(19) United States
(12) Patent Application Publication
(10) Pub. No.: US 2026/0094190 A1
(43) Pub. Date: Apr. 2, 2026

(54) SYSTEMS AND METHODS FOR EMBEDDED SERVICES PLATFORM

(71) Applicant: Worldpay, LLC, Symmes Township, OH (US)

(72) Inventors: Matt DOWNS, Scottsdale, AZ (US); Ian HILLIS, Denver, CO (US); Robert COTHRAN, Denver, CO (US); Eric LERCH, Alamitos, CA (US); James S. OSBORN, Austin, TX (US); Thomas O’CONNELL, Lebanon, OH (US); Kyle WILKING, Mason, OH (US)

(21) Appl. No.: 19/041,439

(22) Filed: Jan. 30, 2025

Related U.S. Application Data
(60) Provisional application No. 63/700,060, filed on Sep. 27, 2024.

(51) Int. Cl. G06Q 30/0601; G06F 9/54

(52) U.S. Cl. CPC G06Q 30/0611; G06F 9/542

(57) ABSTRACT

Various embodiments of this disclosure relate generally to methods and systems for onboarding a partner to an embedded services platform. The method comprises receiving an event notification associated with onboarding the partner, wherein the event notification includes partner data and subscription data, determining a relevant merchant of the partner based on a mapping table for the partner to one or more products of one or more providers, aggregating one or more merchant datasets corresponding to the relevant merchant, transmitting the one or more merchant datasets to the one or more providers for the relevant merchant, and generating one or more offers associated with the one or more products of the one or more providers based on the one or more merchant datasets and the mapping table.

### CROSS-REFERENCE TO RELATED APPLICATION(S)

This application claims the benefit of priority to U.S. Provisional Patent 63/700,060 , filed Sep. 27, 2024, the entirety of which is incorporated by reference herein.

### FIELD OF DISCLOSURE

Various embodiments of the present disclosure relate generally to an embedded services platform, and more particularly, to an embedded services platform that provides merchants with embedded services from partner providers.

### BACKGROUND

Individual integrations to various third-party providers requires significant development effort and coordination among partners and merchants.

The present disclosure is directed to overcoming one or more of these above-referenced challenges.

### SUMMARY

According to certain aspects of the disclosure, methods and systems are disclosed for partner onboarding to an embedded services platform that provides merchants with embedded services from providers and incorporating partner data.

In one aspect, an exemplary computer-implemented method for onboarding a partner in an embedded services platform. The computer-implemented method include receiving, by one or more processors of the embedded services platform, an event notification associated with onboarding the partner, wherein the event notification includes partner data and subscription data. The computer-implemented method may further include determining, by the one or more processors of the embedded services platform, a relevant merchant of the partner based on a mapping table for the partner to one or more products of one or more providers. The computer-implemented method may further include aggregating, by the one or more processors of the embedded services platform, one or more merchant datasets corresponding to the relevant merchant. The computer-implemented method may further include transmitting, by the one or more processors of the embedded services platform, the one or more merchant datasets to the one or more providers for the relevant merchant. The method may further include generating, by the one or more processors of the embedded services platform, one or more offers associated with the one or more products of the one or more providers based on the one or more merchant datasets and the mapping table.

In a further aspect, an exemplary system for onboarding a partner in an embedded services platform. The system may include a memory having processor-readable instructions stored and one or more processors configured to access the memory and execute the processor-readable instructions, which when executed by the one or more processors configures the one or more processors to perform a plurality of functions. The functions may include receiving, by the one or more processors of the embedded services platform, an event notification associated with onboarding the partner, wherein the event notification includes partner data and subscription data. The functions may further include determining, by the one or more processors of the embedded services platform, a relevant merchant of the partner based on a mapping table for the partner to one or more products of one or more providers. The functions may further include aggregating, by the one or more processors of the embedded services platform, one or more merchant datasets corresponding to the relevant merchant. The functions may further include transmitting, by the one or more processors of the embedded services platform, the one or more merchant datasets to the one or more providers for the relevant merchant. The functions my further include generating, by the one or more processors of the embedded services platform, one or more offers associated with the one or more products of the one or more providers based on the one or more merchant datasets and the mapping table.

In a further aspect, an exemplary non-transitory computer-readable medium containing instructions for onboarding a partner in an embedded services platform. The instructions may include receiving, by one or more processors of the embedded services platform, an event notification associated with onboarding the partner, wherein the event notification includes partner data and subscription data. The instructions may further include determining, by the one or more processors of the embedded services platform, a relevant merchant of the partner based on a mapping table for the partner to one or more products of one or more providers. The instructions may further include aggregating, by the one or more processors of the embedded services platform, one or more merchant datasets corresponding to the relevant merchant. The functions may further include transmitting, by the one or more processors of the embedded services platform, the one or more merchant datasets to the one or more providers for the relevant merchant. The functions may further include generating, by the one or more processors of the embedded services platform, one or more offers associated with the one or more products of the one or more providers based on the one or more merchant datasets and the mapping table.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary network computing environment, according to one or more embodiments.

FIG. 2 depicts an exemplary architecture for an embedded services platform, according to one or more embodiments.

FIG. 3 depicts an exemplary architecture for workflow orchestration, according to one or more embodiments.

FIG. 4 depicts exemplary detailed flowchart of the workflows in the workflow orchestration layer, according to one or more embodiments.

FIG. 5 depicts an example flowchart for exemplary process for implementing split settlements, according to one or more embodiments.

FIG. 6 depicts an example flowchart for an exemplary process for embedding partner styling in an application for services and offers from the provider, according to one or more embodiments.

FIG. 7 depicts an exemplary method for utilizing the embedded services platform of FIG. 2, according to one or more embodiments.

FIG. 8 depicts an example flowchart of the process to onboard a partner, according to one or more embodiments.

FIG. 9 depicts an example flowchart of mapping partners with provider products, according to one or more embodiments.

FIG. 10 depicts an example of a computing device that may execute the techniques described herein, according to one or more embodiments.

### DETAILED DESCRIPTION OF EMBODIMENTS

A need exists for a platform that leverages access to providers and potential partners and integrates the products and services of a provider with existing partner relationships, knowledge bases, and data. An embedded services platform may allow one or more software providers to easily launch new embedded products for the benefit of their partners. The embedded services platform may reduce development effort by integrating white-label software products into the platform. This may significantly reduce the development time compared to bespoke integrations of various third-party providers. Current software and web application design techniques require that providers, individually or in conjunction with partners, develop software specific to each provider-partner-merchant relationship to provide an environment customized to the entities of the provider-partner-merchant. An embedded services platform may leverage a single no-code, low-code, or pro-code integration of provider services with customized styling and/or theming of a partner. A partner utilizing the embedded services platform may have access to a suite of embedded service providers and their product offerings. An embedded services platform may leverage native, white-labeled portals, embeddable, white-labeled widgets, and/or direct application programming interface (API) integrations and present the one or more services to merchants via a graphical user interface (GUI) of the embedded services platform. This may allow a provider and/or partner to choose the integration type that most aligns with the strategy and development of their entity. The integration of these provider services also creates a customizable use of services that may evolve over time and be adjusted via embedded services platform without requiring providers and/or partners to develop new software, web applications, etc. to integrate and provide services for a merchant.

The embedded services platform may provide methods and systems for onboarding a partner. During onboarding the embedded services platform may identify relevant provider products and/or services for merchants associated with a partner. By onboarding a partner, the embedded services platform may share anonymized data of the merchant with providers via a data pipeline. Based on the data sent via the data pipeline, the provider offers may be generated for merchants associated with the onboarded partner, and made available via an embedded widget of the embedded services platform.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In the detailed description herein, references to “embodiment,” “an embodiment,” “one non-limiting embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In general, terminology can be understood at least in part from usage in context. For example, terms, such as “and”, “or”, or “and/or,” as used herein can include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and can, instead, allow for the existence of additional factors not necessarily expressly described, again, depending at least in part on context.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.” As used herein, the singular forms “a,” “an,” and “the” include plural reference unless the context dictates otherwise. Relative terms such as “about,” “substantially,” and “approximately” refer to being nearly the same as a referenced number or value, and should be understood to encompass a variation of ±5% of a specified amount or value.

As used herein, a “model” or “machine-learning model” generally encompasses instructions, data, and/or a model configured to receive input, and apply one or more of a weight, bias, classification, or analysis on the input to generate an output (e.g., a video, a text-based output, or an audio output). The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. Any suitable type of training may be used, e.g., stochastic, gradient boosted, random seeded, recursive, epoch or batch-based, etc.

Certain non-limiting embodiments are described below with reference to block diagrams and operational illustrations of methods, processes, devices, and apparatus. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

According to certain aspects of the disclosure, architecture, systems, and methods for an embedded services platform are disclosed. The embedded services platform may act as an intermediary among the one or more providers, partners, and associated merchants to provide services, offers, and/or secure data sharing in an embedded white-label environment matching the native applications of the provider and/or partner.

A need exists for a platform that leverages access to providers and potential partners and associated merchants and integrates the products and services of a provider with existing partner relationships, knowledge bases, and data. An embedded services platform may allow one or more software providers to easily launch new embedded products for the benefit of their partners. The embedded services platform may reduce development effort by integrating white-label software products into the platform. This may significantly reduce the development time compared to bespoke integrations of various third-party providers. An embedded services platform may leverage a single no-code, low-code, or pro-code integration of provider services. A partner utilizing the embedded services platform may have access to an ever-expanding suite of embedded providers and their product offerings. An embedded services platform may leverage native, white-labeled portals, embeddable, white-labeled widgets, and/or direct application programming interface (API) integrations, and present the one or more services to partners via a graphical user interface of the embedded services platform. This may allow a partner to choose the integration type that most aligns with the strategy and development of their organization and/or entity. The embedded services platform may allow providers and partner to reduce the infrastructure required to provide services for partners and/or merchants.

By using the embedded services platform as an intermediary, the providers, partners, and associated merchants may securely share data with one another that is automatically generated, aggregated, and anonymized. The embedded services platform may utilize existing databases and processes to collect this data and directly provide the collected data to providers, partners, and associated merchants as needed, which may reduce the repeated transfer of data between the two parties and may lower the risk of sharing data. The integration of these provider services also creates a customizable use of services that may evolve over time and be adjusted via the embedded services platform.

An embedded services platform may include an authentication layer configured to receive data from a partner device, a merchant device, and a provider device, and authenticate the data. The embedded services platform may include an application layer accessible via authentication from the authentication layer, configured to receive data associated with a request from the partner device, the merchant device, and the provider device. The embedded services platform may include a workflow orchestration layer configured to implement one or more event-triggered workflows based on the data associated with the request received from the application layer. The embedded services platform may include one or more databases configured to store the data associated with the request. The embedded services platform may include a data pipeline configured to transmit data stored in the one or more databases to the partner device, the merchant device, and the provider device.

A method for utilizing an embedded services platform may include receiving, by one or more processors of an embedded services platform, a request from a merchant device to integrate one or more embedded services from one or more providers. The method may include aggregating, by the one or more processors of the embedded services platform, one or more merchant datasets of the merchant account, wherein the one or more merchant datasets are stored in a database of the embedded services platform. The method may include transmitting, by the one or more processors of the embedded services platform, the one or more aggregated merchant datasets to the one or more providers. The method may include receiving, by the one or more processors of the embedded services platform offer data from the one or more providers. The method may include generating, by the one or more processors of the embedded services platform, one or more embedded widgets based on the offer data from the one or more providers. The method may include transmitting, by the one or more processors of the embedded services platform, the one or more embedded widgets to a merchant device associated with the merchant account, wherein the one or more embedded widgets are configured to display the offer data from the one or more providers.

A non-transitory computer-readable medium may include instructions to utilize an embedded services platform. The instructions may include receiving, by one or more processors of an embedded services platform, a request from a merchant device to integrate one or more embedded services from one or more providers. The instructions may include aggregating, by the one or more processors of the embedded services platform, one or more merchant datasets of the merchant account, wherein the one or more merchant datasets are stored in a database of the embedded services platform. The instructions may include transmitting, by the one or more processors of the embedded services platform, the one or more aggregated merchant datasets to the one or more providers. The instructions may include receiving, by the one or more processors of the embedded services platform offer data from the one or more providers. The instructions may include generating, by the one or more processors of the embedded services platform, one or more embedded widgets based on the offer data from the one or more providers. The instructions may include transmitting, by the one or more processors of the embedded services platform, the one or more embedded widgets to a merchant device associated with the merchant account, wherein the one or more embedded widgets are configured to display the offer data from the one or more providers.

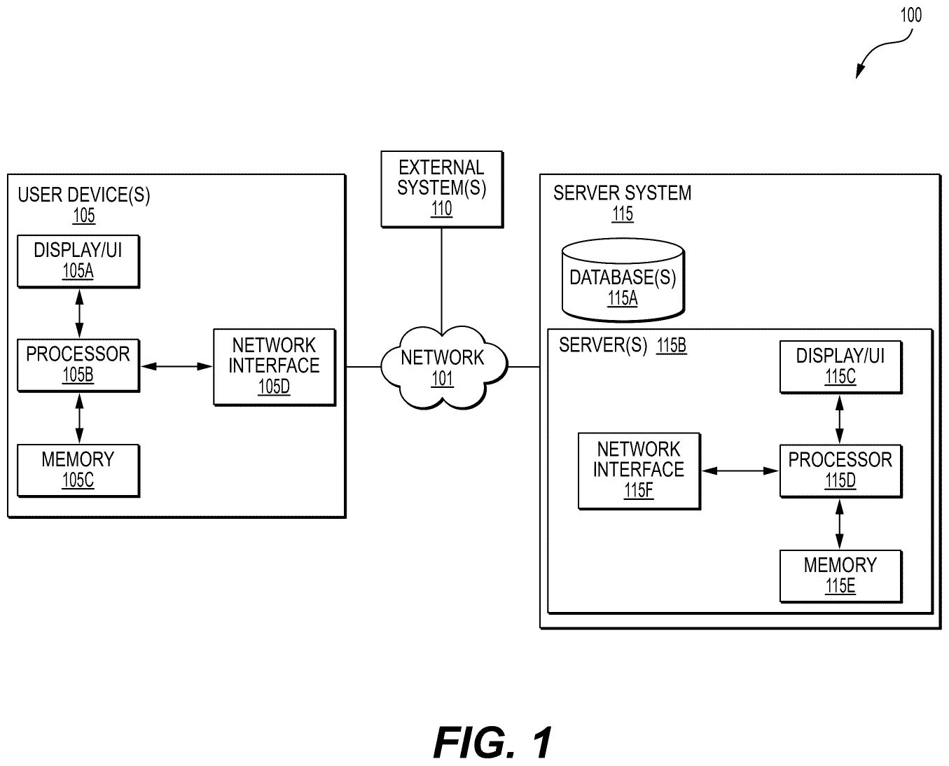

FIG. 1 depicts an exemplary environment 100 that may be utilized with techniques presented herein. A user device 105, one or more external system(s) 110, and one or more server system(s) 115 may communicate across a network 101. As will be discussed in further detail below, one or more server system(s) 115 may communicate with one or more of the other components of the environment 100 across network 101. The user device 105 may be associated with one or more users and/or user accounts, e.g., a provider user account and/or a partner user account used to develop, access, and communicate to provide and access the embedded services.

The components of the environment 100 may be associated with a common entity. One or more components of the environment 100 may be associated with a different entity than another component. The systems and devices of the environment 100 may communicate in any arrangement. As will be discussed herein, systems and/or devices of the environment 100 may communicate in order to generate and transmit the embedded services of a provider to partners.

The user device 105 may be configured to enable the user to access and/or interact with other systems in the environment 100. For example, the user device 105 may be a computer system such as, for example, a desktop computer, a mobile device, a tablet, etc. The user device 105 may include one or more electronic application(s), e.g., a program, plugin, browser extension, etc., installed on a memory 105C of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (e.g., a browser program in a mobile O/S), an applicant specific program, system control software, system monitoring software, software development tools, or the like. For example, environment 100 may extend information on a web client that may be accessed through a web browser such as a merchant portal, provider portal, and/or partner portal of the embedded services platform. The electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may perform one or more operations prior to providing an output to the network 101.

External systems 110 may be, for example, one or more third party and/or auxiliary systems that integrate and/or communicate with the server system 115. For example, external systems 110 may include one or more cloud-computing platforms and/or services utilized by user device 105 and/or server system 115 to host the application asset(s). External systems 110 may include native applications of the one or more partners and/or providers. External system 110 may include integrated software vendors and/or payment facilitators working with providers and/or partners via the embedded services platform. External systems 110 may include one or more machine-learning models and/or generative artificial intelligence (AI) used to onboard one or more providers, partners, and/or associated merchants, aggregate partner, provider, and/or merchant data, generate widgets for embedding services of providers, and/or generate provider offers. External systems 110 may be in communication with other device(s) or system(s) in the environment 100 over the one or more networks 101. For example, external systems 110 may communicate with the server system 115 via API (application programming interface) access over the one or more networks 101, and also communicate with the user device 105 via web browser access over the one or more networks 101. External systems 110 may communicate via one or more portals of the embedded service platform. For example, one or more partners, providers, and/or merchants may access portals via an application layer of the embedded services platform.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may refer to connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In some embodiments, the server system 115 includes and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system may store or have access to database 115A (e.g., hosted on a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may be used to implement the embedded services platform in environment 100 and create a centralized platform for providers, partners, and/or associated merchants to interact while embedding the native applications of the providers and/or partner. The server system 115 may include a machine-learning model and/or instructions associated with the machine-learning model, e.g., instructions for generating a machine-learning model, training the machine-learning model, using the machine-learning model, etc. The server system 115 may include data used by the one or more applications hosted by external system(s) 110, such as demographic data, transaction data, and/or additional data related to the interactions of partners, providers, and merchants. The machine-learning model may generate offers, applications, and/or additional services of providers based on the data stored in database(s) 115A.

A system or device other than the server system 115 may be used to generate and/or train the machine-learning model. For example, such a system may include instructions for generating the machine-learning model, the training data and ground truth, and/or instructions for training the machine-learning model. A resulting trained machine-learning model may then be provided to the server system 115.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to analyze data sources, such as data stored in database(s) 115A, to generate offers, applications, and or other services of partners and or providers. The data may include documents, such as contracts, agreements, licenses, and/or similar documents governing the relationship between providers, partners, and/or associated merchants.

In various embodiments, the variables of a machine-learning model may be interrelated in any suitable arrangement in order to generate the output. For example, in some embodiments, the machine-learning model may include signal processing architecture that is configured to identify, isolate, and/or extract features, patterns, and/or structure in a text. For example, the machine-learning model may include one or more convolutional neural network (“CNN”) configured to identify features in the document information data, and may include architecture, e.g., a connected layer, neural network, etc., configured to generate offers, applications, and or other services of partners and or providers.

Although depicted as separate components in FIG. 1, it should be understood that a component or portion of a component in the environment 100 may, in some embodiments, be integrated with or incorporated into one or more other components. For example, a portion of the display/UI 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

The machine-learning model may be utilized to generate one or more services of a provider for a partner and or merchant, generate one or more offers from a provider to a partner and/or merchant, and/or portioning of transaction amounts. Environment 100 may include displaying the one or more services, one or more offers, and/or additional data via partner, provider, and/or merchant portals. In these methods, various acts may be described as performed or executed by a component from FIG. 1, such as the server system 115, the user device 105, or components thereof. However, it should be understood that in various embodiments, various components of the environment 100 discussed above may execute instructions or perform acts including the acts discussed above and below. An act performed by a device may be considered to be performed by a processor, actuator, or the like associated with that device. Further, it should be understood that in various embodiments, various operations may be added, omitted, and/or rearranged in any suitable manner.

In general, any process or operation discussed in this disclosure that is understood to be computer-implementable, such as the processes illustrated, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

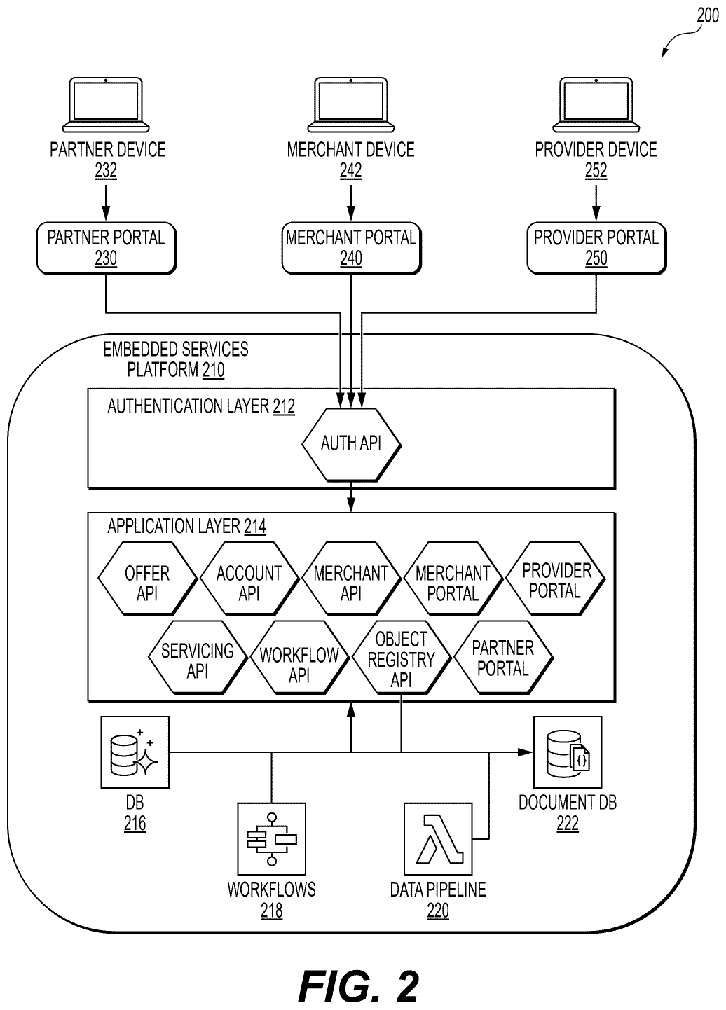

FIG. 2 depicts an exemplary architecture 200 for an embedded services platform 210, according to one or more embodiments. Architecture 200 may be implemented by one or more processors of a server that is in communication with one or more mobile devices and other external system(s) via a network. However, it should be noted that architecture 200 may be implemented by any one or more of the server, one or more user devices, or other external systems. In some embodiments, embedded services platform 210 may utilized a layered architecture such that each layer of the platform described below (e.g., authentication, application, and workflow orchestration) and/or the sub-components of the layers may be containerized. The containerized layers may be individually executed anywhere they are assigned in a cloud-based and/or local environment. This may allow the architecture 200 to use computer resources more efficiently and increase security for the platform. In some embodiments, embedded service platform 210 may be implemented in a virtual private cloud.

The embedded service platform 210 may act as an intermediary among partners, merchants, and providers. In some embodiments, embedded services platform may act as an intermediary to for providers of financial services (e.g., financing, payment vehicles, loans, capital, etc.) to work with partners (e.g., integrated software vendors and/or payment facilitators) and merchants. In some embodiments, partners may have existing relationships with a plurality of merchants. Providers may communicate with partners and/or merchants directly to provide financial services. Additionally or alternatively, partners and providers may have specific styling and/or theming.

The embedded services platform 210 may include an authentication layer 212 configured to receive data from a partner device 232, a merchant device 242, and a provider device 252, (e.g., user device 105) and authenticate the data. For example, authentication layer 212 may receive a partner identification (ID), a provider ID, and/or a merchant ID and an access token. In some embodiments, authentication layer 212 may include an authentication API. The authentication API may be used to authenticate the partner device 232, the merchant device 242, and the provider device 252 based on the received partner identification (ID), provider ID, and/or merchant ID and corresponding access token.

The embedded services platform 210 may include an application layer 214 accessible via authentication from the authentication layer 212, configured to receive data associated with a webhook event from the partner device 232, the merchant device 242, and the provider device 252. In some embodiments, application layer 214 may include both front-end and back-end components. For example, application layer 214 may include a plurality of portals that are front-end components connecting the partner device 232, the merchant device 242, and the provider device 252 to the embedded services platform 210.

Embedded service platform 210 may also include back-end components, such as application programming interfaces, that facilitate the requests from connecting the partner device 232, the merchant device 242, and the provider device 252. The APIs of application layer 214 may communicate using Hypertext Transfer Protocol (HTTP). For example, application layer 214 may include a merchant API, an offer API, account API, servicing API, workflow API, and object registry API. The merchant API may communicate with the merchant portal and components of the embedded services platform 210 to present information to the merchant device 242. For example, the merchant API may communicate with the offer API and or servicing API to generate an embedded widget presenting an offer, a product, and/or a service from the provider in merchant portal 240.

In some embodiments, offer API and servicing API may communicate with workflow API to generate the appropriate offer and/or service from the provider to the merchant and/or partner. The workflow API may initiate a workflow of the plurality of workflows 218. In some embodiments, the plurality of workflows 218 may include a new partner workflow, an update partner workflow, a provider workflow, and/or an integrated service vendor workflow. The provider workflows may include an offer generation workflow, a marketing workflow, an application workflow, and/or similar workflows to communicate services of the provider to the merchant and/or partners via an embedded widget. For example, based on the data and/or request from the provider device 252, received at an endpoint of an API of application layer 214, one or more workflows of the plurality of workflows 218 may be initiated.

In some embodiments, the embedded services platform 210 may include an object registry configured to receive data from the application layer 214 and/or authentication layer 212. In some embodiments, the object registry may store configuration data in a JSON format associated with application layer 214. The object registry API may receive a request from application layer 214 and return configuration data associated with the request. For example, the request may include source data for a specific type of embedded widget to be generated from an existing shell widget in a partner and/or merchant portal. The object registry may obtain the appropriate configuration data associated with the specific embedded widget and transmit the configuration data to application layer 214 to generate the embedded widget in the partner portal 230 and/or merchant portal 240.

In some embodiments, requests for the object registry may be routed through backend services of embedded services platform 210 via the object registry API of application layer 214. Additionally or alternatively, data pipeline 220 (described in more detail below) may be configured to call an application programming interface (API) to transfer data between embedded services platform 210 and the partner device 232, the merchant device 242, and/or the provider device 252. The endpoints of the object registry may not be exposed outside of embedded services platform 210 (e.g., outside of the virtual private cloud) to prevent bad actors from gaining access to the configuration data. This design may improve security by isolating the object registry from direct external access, and thereby safeguarding the sensitive data and ensuring a single point of authentication.

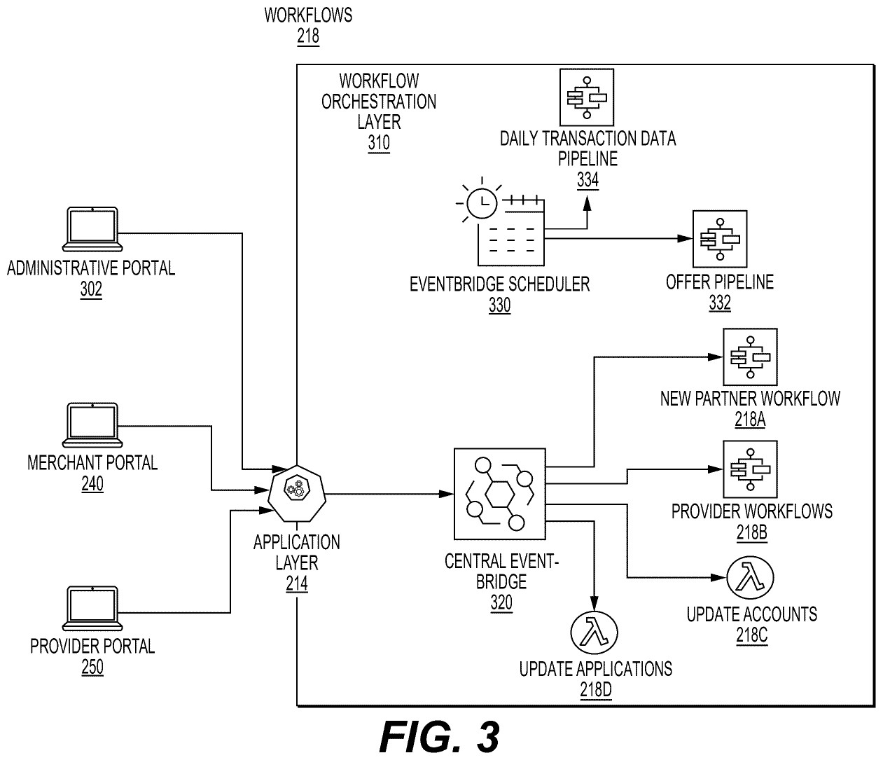

As described with reference to FIG. 3, the embedded services platform 210 may include a workflow orchestration layer 310 configured to implement one or more event-triggered workflows 218. In some embodiments, workflow orchestration layer 310 may receive data from application layer 214 in response to a call or request from a portal. As described above, a request to execute a workflow of the plurality of workflows 218 may be received by an endpoint of the workflow API. The workflow API may then initiate the appropriate workflow based on the request.

The embedded services platform 210 may include one or more databases (e.g., database(s) 115A) configured to store the data associated with the request. Additionally or alternatively, the one or more databases may store data received via data pipeline 220. In some embodiments, embedded services platform 210 may include a database 216 and a documents database 222. The documents database 222 may store documents corresponding to the partner, provider, and/or merchant. Documents database 222 may store documents governing the relationship between a partner, provider, and/or merchant (e.g., a contract, license, etc.) that are relevant to the operations of embedded services platform 210.

For example, a provider may provide financial capital to a merchant. The offer and application process may be executed through the embedded widgets of embedded services platform 210. The repayment process and terms of the financial capital may have been determined outside of embedded service platform 210. The provider device 252 and/or merchant device 242 may send the contract or governing document to embedded services platform 210, which may execute the repayment process (e.g., through daily net-settled sales). Documents database 222 may store the contract, which may be utilized by other components of embedded services platform 210.

The embedded services platform 210 may include a data pipeline 220 configured to transmit data stored in the one or more databases to the partner device 232, the merchant device 242, and the provider device 252 and vice versa. Data pipeline 220 may transfer partner data, merchant data, and/or provider data. For example, data pipeline 220 may transfer merchant demographic data to provider device 252 from database 216. Similarly, data pipeline 220 may receive data (e.g., a contract between a merchant and provider) from partner device 232, merchant device 242, and/or provider device 252.

Although FIG. 2 shows example blocks of exemplary architecture 200, in some implementations, the exemplary architecture 200 may include additional layers and/or components, fewer layers and/or components, different layers and/or components, or differently arranged layers and/or components than those depicted in FIG. 2. Additionally, or alternatively, two or more of the layers and/or components of the exemplary architecture 200 may execute functions in parallel.

FIG. 3 depicts exemplary architectures for workflow orchestration layer 310 in the embedded services platform of FIG. 2. In some embodiments, workflow orchestration layer 310 may execute event-triggered workflows 218. Workflow orchestration layer 310 may include multiple partner, provider, and merchant specific workflows 218 intended to be executed by workflow orchestration layer 310 in response to an event (e.g., a request and/or data) has been received. Workflow orchestration layer 310 may be implemented by one or more processors of a server that is in communication with one or more mobile devices and other external system(s) via a network. However, it should be noted that workflow orchestration layer 310 may be implemented by any one or more of the server, one or more user devices, or other external systems.

Workflow orchestration layer 310 may include central event-bridge 320 and event-bridge scheduler 330. In some embodiments, central event-bridge 320 may trigger one or more workflows of the plurality of workflows 218, based on receiving an event request from an API of application layer 214. In some embodiments, event-bridge scheduler 330 may schedule the one or more workflows that may be automatically repeated, such as daily transaction data pipeline 334 and offer pipeline 332.

In some embodiments, administrative portal 302, merchant portal 240, and/or provider portal 250 may call, e.g., transmit a request, application layer 214. In some embodiments, application layer 214 may generate an event based on the request. Application layer 214 may transmit the event to central event-bridge 320 of workflow orchestration layer 310. Central event-bridge 320 may then trigger the correct workflow 218 based on the event received. In some embodiments, the API call may be a call from a portal (e.g., administrative portal 302, merchant portal 240, and/or provider portal 250) to a specific API (e.g., a merchant API, offer API, servicing API, etc.) of application layer 214. Each API of application layer 214 may be designed to generate corresponding events based on the requests received from the portals.

For example, in some embodiments, administrative portal 302 may be a portal for administrators of embedded services platform 210 to perform administrative workflows, e.g., onboarding providers and/or partners. Administrative portal 302 may call account API of application layer 214 to onboard a partner. Account API may generate an event to trigger new partner workflow 218A. The call from administrative portal 302 to the account API may also include partner data used in new partner workflow 218A. The partner data may be stored in database 216 and/or documents database 222. In some embodiments, a similar workflow may exist for onboarding providers and/or merchants.

Additionally or alternatively, workflows 218 may include a change partner workflow. The change partner workflow may modify the association of a provider and/or merchant with a partner and/or modify partner data. A partner may remove or add an association with a merchant and/or provider. In some embodiments, a partner may modify the partner themed styling for merchants related to a partner. There may be multiple change partner workflows that execute these tasks within workflow orchestration layer 310 and embedded services platform 210.

In some embodiments, central event-bridge 320 may include new partner workflow 218A and provider workflows 218B. Provider workflows 218B may include offer generation workflows, marketing workflows, application workflows and/or other workflows associated with generating a provider offer, service, and/or application for merchants via an embedded widget. Additionally or alternatively, central event-bridge 320 may include update workflows. For example, update accounts workflow 218C and update applications workflows 218D. Update account workflow 218C may be executed to update an account of a merchant, partner, and/or provider. For example, data pipeline 220 may receive data associated with a merchant, such as demographic data and/or transaction data. In response, application layer 214 may generate an event to trigger central event-bridge 320 to execute an update applications workflow 218D. The account of the merchant may then be updated accordingly to reflect the data received by data pipeline 220. Additionally, the data may be stored in database 216 and/or documents database 222.

In some embodiments, event-bridge scheduler 330 may schedule and automatically trigger execution of workflows 218 on a periodic basis. For example, merchant data, such as merchant transaction data, may be received and updated on a daily basis. The merchant may actively be using a service of the provider, e.g., a financial service such as credit cards, loans, financing, etc. The active service may trigger a daily transaction data pipeline 334 of event-bridge scheduler 330. Daily transaction data pipeline 334 may transmit the aggregated daily sales to the provider device 252.

Although FIG. 3 shows example blocks of exemplary workflow orchestration layer 310, in some implementations, the exemplary workflow orchestration layer 310 may include additional layers and/or components, fewer layers and/or components, different layers and/or components, or differently arranged layers and/or components than those depicted in FIG. 3. Additionally, or alternatively, two or more of the layers and/or components of the exemplary workflow orchestration layer 310 may execute functions in parallel.

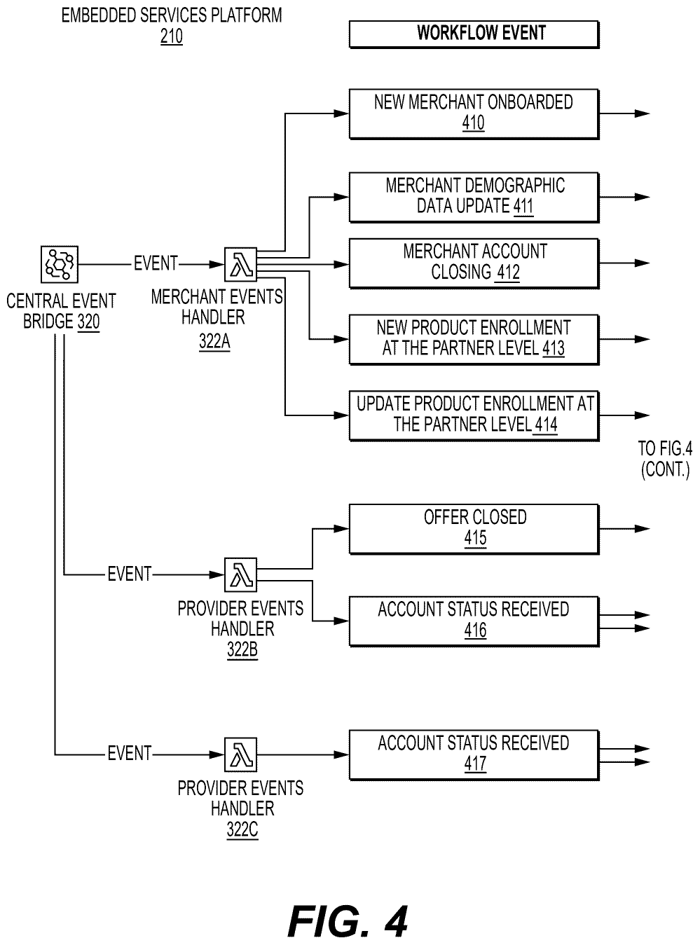

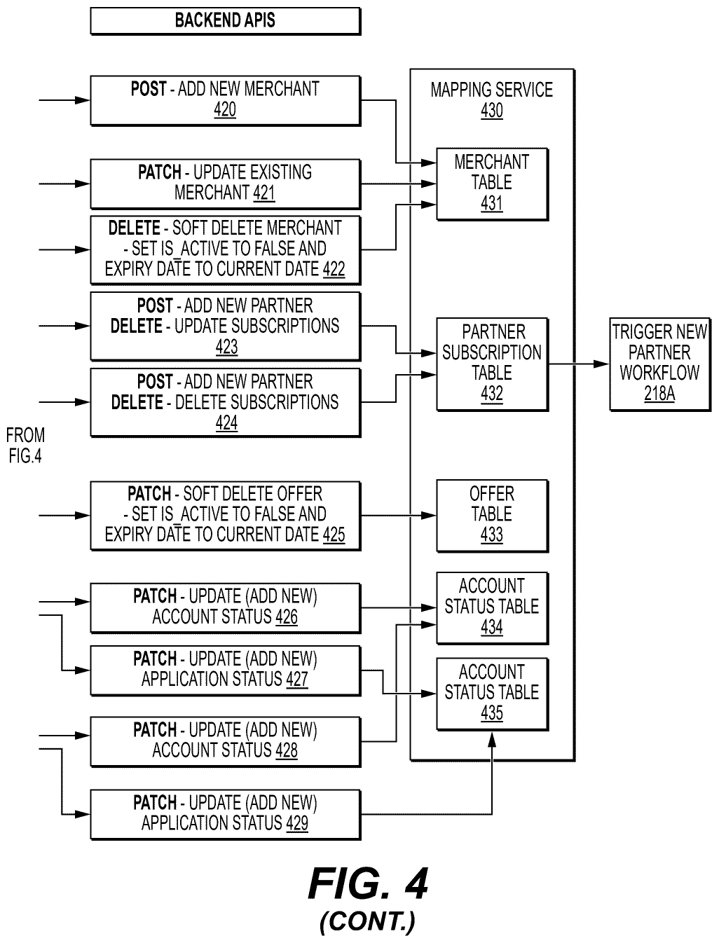

FIG. 4 depicts an exemplary detailed flowchart of workflows 218 described with references to workflow orchestration layer 310 of FIG. 3. Workflows 218 may be performed in workflow orchestration layer 310 by one or more processors of a server that is in communication with one or more mobile devices and other external system(s) via a network. However, it should be noted that workflow orchestration layer 310 may be implemented by any one or more of the server, one or more user devices, or other external systems.

Central eventbridge 320 may include workflows 218 specific to processes performed for merchants and providers. For example, central eventbridge 320 may include merchant events handler 322A, provider events handler 322B, and provider events handler 322C. In some embodiments, different providers may use individualized workflows within central event-bridge 320. The workflows may be specific to the products and services offered by the provider for merchants. In some embodiments, there may be multiple events handlers for each merchant or specific types of merchants, e.g., dependent on the types of goods or services offer by the merchant(s).

Central event-bridge 320 may transmit merchant related events to merchant events handler 322A. Merchant events handler 322A may determine the workflow to execute based on the data transmitted with the event. As described in FIG. 3, data may be first received by application layer 214 in conjunction with a request from administrative portal 302, merchant portal 240, and/or provider portal 250. The data may indicate whether one or more of the workflows should be executed. Merchant workflows may include new merchant onboarded 410, merchant demographic data update 411, merchant account closing 412, new product enrollment at the partner level 413, and/or update product enrollment at the partner level 414.

In some embodiments, the workflow new merchant onboard may include receiving merchant demographic data for a new merchant. Demographic data may include identifying information, addresses, contact information, and/or additional data related to the demographics of the merchant. Merchant events handler 322A may send an HTTP POST request including the data associated with the event to application layer 214 to execute function add merchant (operation 420). Application layer 214 may create a merchant account via account API. A unique merchant ID may be generated by account API and/or backend services of application layer 214. In some embodiments, an embedded services platform merchant account may be linked with an existing merchant account of the financial institution or entity operating embedded services platform 210.

In some embodiments, the workflow merchant demographic data update 411 may include receiving updated demographic data for an existing merchant. Merchant events handler 322A may send an HTTP PATCH request including the data associated with the event to application layer 214 to execute a function to update the demographic data of merchant (operation 421). Application layer 214 may update the existing merchant account via account API. The PATCH request may include the unique merchant ID of the existing merchant which may be used by account API and/or backend services of application layer 214 to identify the merchant account and update the demographic data.

In some embodiments, the workflow merchant account closing 412 may include receiving a request to close the account of an existing merchant. Merchant events handler 322A may send an HTTP DELETE request including the unique merchant ID to application layer 214 to execute a function to delete the account and related data of the merchant (operation 422). Application layer 214 may delete the existing merchant account via account API. In some embodiments, the delete function (operation 422) may be a soft delete with an expiration of the current date or a future date so that the account may be recovered.

In some embodiments, application layer 214 may provide the account data to mapping services 430 after operation 420, operation 421, and operation 422. Mapping service 430 may add the merchant account data to merchant table 431. Merchant table 431 may be used by provider and partner workflows to identify provider products and/or services that may be relevant to the merchant.

In some embodiments, the workflow new product enrollment at the partner level 413 may include receiving a request and partner product data to enroll all merchants associated with a partner in a new product. Merchant events handler 322A may send an HTTP POST request to add a new partner to embedded services platform 210 and a DELETE request to update partner subscriptions (operation 423). Application layer 214 may receive data from partner portal 230 regarding a new partner product.

In some embodiments, the workflow update product enrollment at the partner level 414 may include receiving a request and partner product data to update the product enrollment for all merchants associated with a partner based on an update to one or more partner products. Merchant events handler 322A may send an HTTP POST request to add a new partner to embedded services platform 210 and a DELETE request to delete the previously existing subscriptions (operation 424). Application layer 214 may receive data from partner portal 230 regarding an update to one or more partner products.

In some embodiments, application layer 214 may provide the account data to mapping services 430 after operation 423 and operation 424. Mapping service 430 may update partner subscription table 432. Partner subscription table 432 may include the products of the partners and merchants associated with the products e.g., partner subscriptions. In some embodiments, each partner subscription has a unique subscription ID which identifies all of the merchant associated with the partner product subscription. In some embodiments, the update to the partner subscription table may trigger another workflow, new partner workflow 218A.

Central event-bridge 320 may transmit provider related events to provider events handler 322B. As described in FIG. 3, data may be first received by application layer 214 in conjunction with a request from administrative portal 302, merchant portal 240, and/or provider portal 250. The data received by application layer 214 may include a provider ID. Central event-bridge 320 may determine which provider events handler (e.g., 322B or 322C) based on the provider ID included in the request. The data of the request may indicate one or more of the workflows should be executed. Provider workflows may include offer closed 415, account status received 416, and account status received 417. In some embodiments, account status received 416 and account status received 417 may have identical functions for different providers.

In some embodiments, the workflow offer closed 415 may include receiving a request and data to close a provider offer. For example, an offer for a loan, payment vehicle (e.g., credit card, debit card, etc.), or another offer related to a provider product or service may be closed by the provider. Provider events handler 322B may send an HTTP PATCH request to soft delete offer (operation 425). Application layer 214 may delete the existing merchant account via account API. In some embodiments, the delete function (operation 425) may be a soft delete with an expiration of the current date or a future date so that the account may be recovered.

In some embodiments, application layer 214 may provide the close or deleted offer data to offer table 433. Mapping service 430 may update offer table 433 accordingly. Offer table 433 may be used by offer API to manage the provider offers for each merchant and/or partner. In some embodiments, application layer 214 may receive data from provider portal 250 including an offer ID. The offer ID may be associated with the specific offer the provider is requesting to close. In some embodiments, the offer may be closed for a specific merchant, group of merchants, and/or partner.

In some embodiments, the workflow account status received 416 (and similarly account stats 417) may include receiving a request and data to update the account status of a provider. Provider events handler 322B (and similarly provider events handler 322C) may each send two HTTP PATCH requests (operation 426, operation 427, operation 428, and operation 429) to update (add new) account status. In some embodiments, application layer 214 may provide the updated account status data to account status table 434 and account status table 435 of mapping service 430.

Although FIG. 4 shows example blocks of exemplary workflows 218 in the workflow orchestration layer of FIG. 3, in some implementations, exemplary workflows 218 may include additional blocks, fewer blocks, different blocks, or differently arranged blocks than those depicted in FIG. 3. Additionally, or alternatively, two or more of the layers and/or components of the workflows 218 may execute functions in parallel.

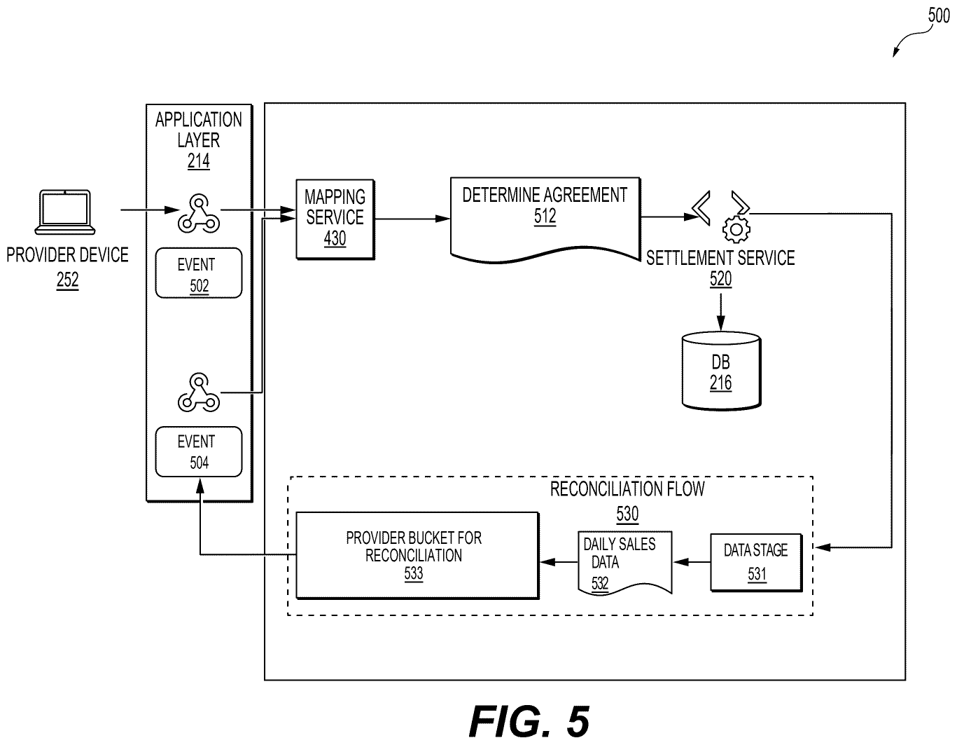

FIG. 5 depicts an example flowchart for process 500 performed using the embedded services platform of FIG. 2. Process 500 may be performed by one or more processors of a server that is in communication with one or more mobile devices and other external system(s) via a network. However, it should be noted that process 500 may be implemented by any one or more of the server, one or more user devices, or other external systems.

The process 500 may include a provider device 252 that may transmit split settlement data to embedded services platform 210 (502). In some embodiments, application layer 214 may receive a request and data related to split settlements between a provider and merchant. The split settlement data may indicate how net-sales determined from transaction data stored in database 216 may be split between a merchant and provider. In some embodiments, the split settlement agreement may exist between a merchant, provider, and partner. Application layer 214 may generate an event and transmit the event to central event-bridge 320 to execute a corresponding provider workflow. The data may include a merchant ID, provider ID, partner ID, offer ID, and/or subscription ID.

Mapping service 430 may use the merchant ID, provider ID, partner ID, offer ID, and/or subscription ID transmitted with the request to determine the parties involved in the split settlement agreement (operation 512). In some embodiments, a merchant may be using one or more services or products of a provider. The split settlement agreement may apply to each of the active services or products.

In some embodiments, settlement service 520 may receive the split settlement data and retrieve split settlement rules from database 216. Split settlement rules may indicate a hierarchy of the services and products for the split settlement. For example, if a merchant has multiple loans, there may be a hierarchy of loans for settling the net-sales. Additionally, there may be a daily cap associated with the split settlement agreement that is defined by the split settlement rules. For example, there may a maximum currency amount that may be applied to one or more of the active services or products.

The split settlement rules may be used by settlement service 520 to determine how the net-sales should be settled for each party regarding each service or product. In some embodiments, net-sales may be settled daily, weekly, monthly, and/or by another predetermined time period. The predetermined time period may be determined in the agreement between the merchant(s), provider(s), and or partner(s), which may be stored in documents database 222. In some embodiments, the settlement data may include the predetermined time period.

In some embodiments, reconciliation flow 530 may reconcile the net-sales according to the split settlement agreement and split settlement rules. Data stage 531 may store the transaction data associated with the net-sales. Data stage 531 may receive the transaction data from the financial institution or entity implementing embedded services platform 210. Daily sales data 532 may aggregate the daily net-sales of the merchant based on the transaction data in data stage 531. In some embodiments, daily sales data 532 may aggregate sales data according to the predetermined time period other than a daily time period.

Provider bucket for reconciliation 533 may receive the aggregated sales data for the merchant. In some embodiments, a provider may have split settlement agreements with multiple merchants. Provider bucket for reconciliation 533 may receive the aggregated sales data for each merchant with a split settlement agreement. Each provider may have a provider bucket for reconciliation 533.

The provider and the merchant may have financial accounts with the financial institution or entity implementing embedded services platform 210. Embedded services platform 210 may prompt the response service of the financial institution and/or entity to transmit the provider amount and the merchant amount to the account of provider account and the merchant account, respectively. In some embodiments, the provider amount and/or the merchant amount may be transmitted to an external financial institution as specified in the agreement between the provider and the merchant. Embedded services platform 210 may prompt the response service the financial instruction and/or entity to transmit the provider amount and/or merchant amount the corresponding provider account and/or merchant account identified in the agreement.

In some embodiments, application layer 214 may generate event 504 in response to the aggregated sales data being received by provider bucket for reconciliation 533. This process may repeat until the service or product is terminated by the end of the agreement between the provider and the merchant.

Although FIG. 5 shows example blocks of operations performed using the embedded services platform of FIG. 2, in some implementations, the exemplary process 500 may include additional blocks, fewer blocks, different blocks, or differently arranged blocks than those depicted in FIG. 5. Additionally, or alternatively, two or more of the layers and/or components of the process 500 may execute functions in parallel.

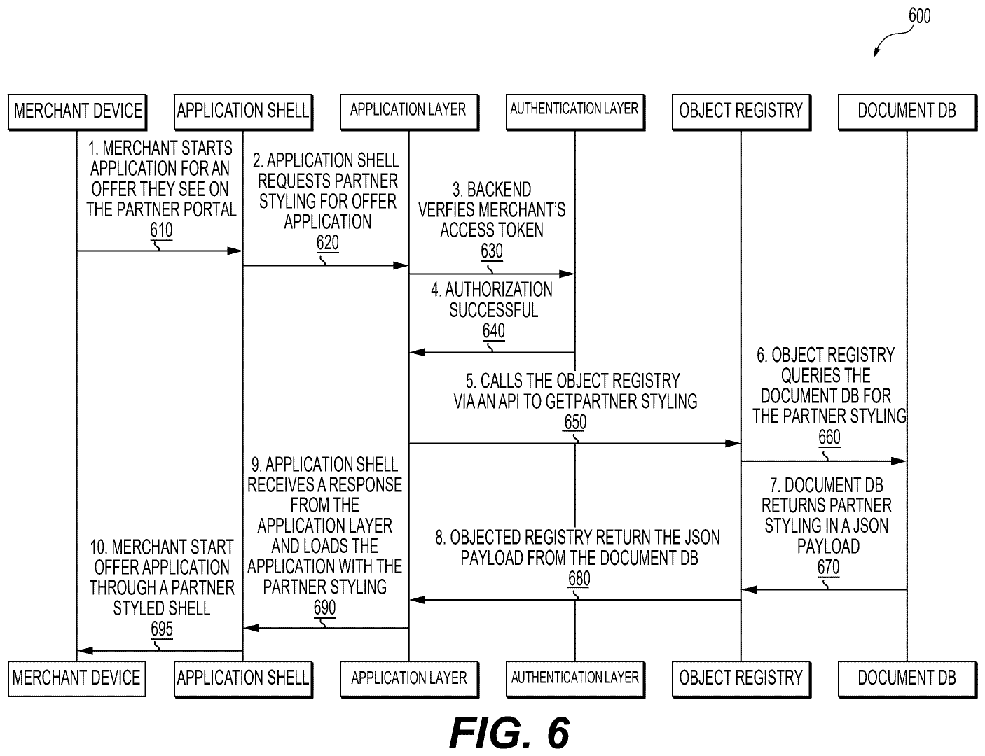

FIG. 6 depicts an example flowchart for an exemplary process 600 for embedding partner styling in an application for services and offers from the provider using the embedded services platform 210 of FIG. 2. Process 600 may be implemented by one or more processors of a server that is in communication with one or more mobile devices and other external system(s) via a network. However, it should be noted that process 600 may be implemented by any one or more of the server, one or more user devices, or other external systems.

The embedded service platform 210 may act as an intermediary among partners, merchants, and providers. In some embodiments, embedded services platform 210 may act as an intermediary for providers of financial services (e.g., financing, payment vehicles, loans, capital, etc.) to work with partners (e.g., integrated software vendors and/or payment facilitators) and merchants. In some embodiments, partners may have existing relationships with a plurality of merchants. Providers may communicate with partners and/or merchants directly to provide financial services. The offers, services, and/or applications from providers and/or partner may be presented in the merchant portal via an embedded widget. Additionally or alternatively, partners and providers may have specific styling and/or theming to present offer, services, and/or applications to the merchants via the embedded widgets of embedded services platform 210. The embedded widget may be rendered to mimic the theming, branding, etc. of the provider and/or partner, without requiring the merchant to leave the merchant portal of the embedded services platform 210.

The process 600 may include a merchant device 242 interacting with an embedded widget in merchant portal 240 (610). In some embodiments, merchant device 242 may select an offer for a service of a provider. For example, merchant device 242 may receive a selection of an offer for a loan from a provider. The selection of the offer and/or service from the provider may trigger generation of an embedded widget for an application.

In some embodiments, the offer may be presented through a shell widget. The shell widget may be generated by application layer 214 based on offer data stored in database 216. In some embodiments, providers may send offer data to embedded services platform 210 via data pipeline 220. The offer data may be transmitted to embedded services platform 210 based on the provider receiving aggregated of merchant data via data pipeline 220. In some embodiments, embedded services platform 210 may generate a standardized offer for a merchant from a provider.

In some embodiments, provider offers and services are generated through an existing embedded shell widget in application layer 214. The shell widget may render specific offers, services, and/or applications based on data received by application layer 214. In some embodiments, there may be different types of embedded shell widgets. For example, there may be an embedded shell offer widget, and embedded shell service widget, and/or an embedded shell application widget.

The process 600 may include an embedded application shell widget that may request partner themed styling for an offer application in response to the selection of the offer by merchant device 242 (620). The embedded application shell widget may call an API of application layer 214. Prior to completing the request and retrieving the styling and theming data, embedded services platform 210 may verify merchant credentials.

In some embodiments, process 600 may include backend services of the embedded service platform 210 and authentication layer 212 verifying a merchant access token prior to rending the offer application in the embedded shell widget (operation 630 and operation 640). For example, merchant device 242 may enter access credentials when accessing merchant portal 240. These access credentials may include a merchant ID and/or an access token. The access credentials may be passed to authentication layer 212 to verify merchant device 242 has access to merchant portal 240 and offers, services, and applications as well as sensitive data presented in merchant portal 240. If the merchant ID and access token are verified, the process may continue.

As described with reference to 620, application layer 214 may call the object registry to retrieve the custom theming and/or styling (650). In some embodiments, offer API of application layer 214 may pass data to and from the embedded widget to render the offer and/or offer application in the embedded shell widget. After receiving a selection, offer API may request partner themed styling for the widget from object registry API. Object registry API may retrieve the configuration data from the object registry for the partner themed styling.

In some embodiments, the process 600 may include the object registry querying the documents database 222 for partner styling (660). In some embodiments, documents database 222 may store partner styling data. The partner styling data may allow the embedded widget to mimic the look and feel of the native website when rendered by application layer 214. In some embodiments, the object registry may identify the correct partner styling based on a partner name and partner identification. The partner styling may be stored by type. For example, and application may have different styling details than an offer or a service.

The process 600 may include documents database 222 returning the partner styling in a JSON payload (670). In some embodiments, based on the partner ID, name of the partner, and type of embedded widget (e.g., offer, application, or service) in the query documents database 222 may return the appropriate partner styling data in a JSON payload.

The process 600 may include object registry returning the JSON payload from the documents database 222 (680). In some embodiments, the object registry may return the partner styling data in a JSON payload to application layer 214. In some embodiments, the object registry may return the JSON payload to the object registry API. Additionally or alternatively, object registry and/or object registry API may return the JSON payload to another API of application layer 214. For example, object registry and/or object registry API may return the JSON payload to the offer API so that the partner styling data may be used when rendering the embedded widget.

The process 600 may include the embedded application shell widget receiving the response from the application layer 214 and loading the embedded application shell widget with the partner styling data (690). Application layer 214 may transmit the JSON payload including the partner styling data to the embedded application shell widget associated with merchant device 242. In some embodiments, a specific API of application layer 214, such as offer API, servicing API, and/or another API of application layer 214 may transmit the JSON payload to the embedded application shell widget.

The process 600 may include merchant device 242 rendering the offer application via the embedded application widget (695). In some embodiments, the embedded application widget may render the partner styling after being loaded in the embedded shell application widget which is accessed via merchant portal 240. Merchant device 242 may display the rendered partner styling data and embedded application widget. A user may interact with merchant device 242 to view and edit the offer and application data of the embedded application widget.

Although FIG. 6 shows example flowchart for an exemplary method for embedding partner styling in an application for services and offers from the provider using the embedded services platform 210 of FIG. 2, in some implementations, the exemplary process 600 may include additional blocks, fewer blocks, different blocks, or differently arranged blocks than those depicted in FIG. 6. Additionally, or alternatively, two or more of the layers and/or components of the process 600 may execute functions in parallel.

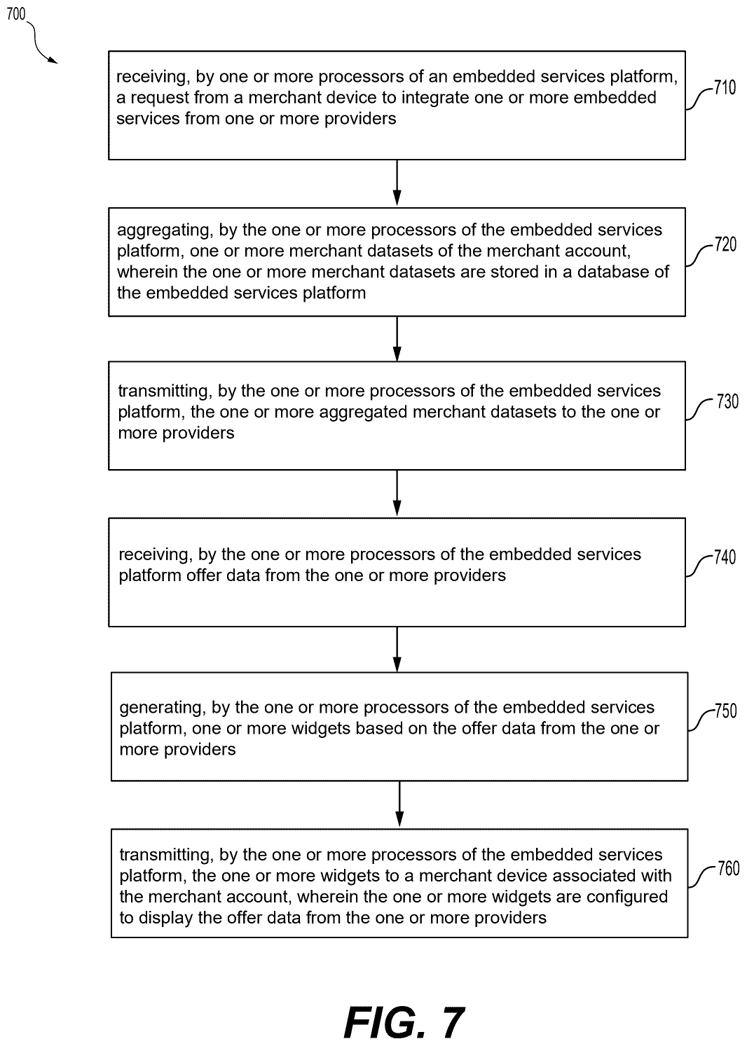

FIG. 7 depicts an exemplary method 700 for utilizing the embedded services platform of FIG. 2. Method 700 may be implemented by one or more processors of a server that is in communication with one or more mobile devices and other external system(s) via a network. However, it should be noted that method 700 may be implemented by any one or more of the server, one or more user devices, or other external systems.

The method 700 may include receiving, by one or more processors of an embedded services platform, a request from a merchant device to integrate one or more embedded services from one or more providers (710). In some embodiments, a merchant may be onboarded to embedded services platform 210. Onboarding the merchant may trigger workflows 218 to update the merchant account and integrate one or more provider offers, applications, and/or services into merchant portal 240. The one or more provider offers, applications, and/or services may be rendered in merchant portal 240 using an embedded shell widget of application layer 214.

In some embodiments, the merchant is associated with a partner account, and the partner account may be associated with a plurality of merchant accounts. For example, a merchant may be associated with a partner such as a payment facilitator and/or integrated software provider. The partner may be onboarded to embedded services platform 210 along with a plurality of merchants. The onboarding of the partner may also trigger workflows 218 to update the merchant account and integrate one or more provider offers, applications, and/or services into merchant portal 240.

The method 700 may include aggregating, by the one or more processors of the embedded services platform, one or more merchant datasets of the merchant account, wherein the one or more merchant datasets are stored in a database of the embedded services platform (operation 720). Embedded service platform 210 may be a component of a financial institution or entity that processes transactions of a merchant or otherwise has access to merchant financial and transaction data. The transaction data may be stored in a database (e.g., database(s) 115A and/or database 216). Embedded services platform 210 may execute workflows 218 to aggregate the transaction data of a merchant over a period of time. For example, transaction data of the merchant may be aggregate over day(s), weeks(s), month(s), and/or year(s). The aggregated data may be stored in database 216.

In some embodiments, the one or more merchant dataset includes demographic data and transaction data associated with the merchant account. For example, demographic data may include identifying information, addresses, contact information, and/or additional data related to the demographics of the merchant.

The method 700 may include transmitting, by the one or more processors of the embedded services platform, the one or more aggregated merchant datasets to the one or more providers (730). In some embodiments, the one or more aggregated merchant datasets may be transmitted to the one or more providers using data pipeline 220. Data pipeline 220 may be a secure file transfer service. Additionally or alternatively, data pipeline 220 may be an API that embedded services platform 210 may call. The request may transmit the one or more aggregated datasets to the one or more providers.

In some embodiments, one or more providers may have products that are relevant to the merchant. The merchant may be presented with offers, applications, and services of multiple providers. Embedded services platform 210 may include a mapping service 430 that maps products and services of providers with relevant merchants. Embedded services platform may transmit the data of the relevant merchants to one or more providers based on the tables of mapping service 430.

The method 700 may include receiving, by the one or more processors of the embedded services platform, offer data from the one or more providers (740). In response to receiving the one or more merchant dataset, the one or more providers may generate offers for the merchant(s). In some embodiments, the offer data may be customized for the specific merchant, e.g., a specialized offer, application process, and/or service. For example, based on the one or more merchant dataset, a provider may generate offer data indicating an offer for a loan with an interest rate specific to the merchant.

In some embodiments, the offer data may be contained in a document. The offer data be received by data pipeline 220 and stored in documents database 222. Embedded service platform 210 may include a service to parse the document to determine the specific offer data that should be rendered in the embedded widget in merchant portal 240. The document may be parsed by extracting the text and converting it to machine-readable text, for example using optical character recognition (OCR) techniques.

The method 700 may include generating, by the one or more processors of the embedded services platform, one or more embedded widgets based on the offer data from the one or more providers (750). In response to receiving the offer data, application layer 214 may generate an embedded offer widget using the embedded shell widgets associated with merchant portal 240. Offer API may retrieve the offer data and generate the embedded services widget with the offer data in merchant portal 240. In some embodiments, the embedded shell widget is configured to receive partner styling data from application layer 214 and render the embedded shell widget with the partner styling data.

In some embodiments, the embedded widget may be generated with partner styling data and one or more provider offers. Application layer 214 may call the object registry to retrieve the custom theming and/or styling. In some embodiments, offer API of application layer 214 may pass data to and from the embedded widget to render the offer using the embedded shell widget. Offer API may request partner themed styling for the widget from object registry API. Object registry API may retrieve the configuration data from the object registry for the partner themed styling.

In some embodiments, the object registry may query the documents database 222 for partner styling. In some embodiments, documents database 222 may store partner styling data. The partner styling data may allow the embedded widget to mimic the look and feel of the native website when rendered by application layer 214. In some embodiments, the object registry may identify the correct partner styling based on a partner name and partner identification.

The method 700 may include transmitting, by the one or more processors of the embedded services platform, the one or more widgets to a merchant device associated with the merchant account, wherein the one or more embedded widgets are configured to display the offer data from the one or more providers (760). Application layer 214 may render the one or more embedded widgets in merchant portal 240. Merchant device 242 may display merchant portal 240 and the user may view and interact with the embedded offer widget via a user interface of the merchant device 242.

In some embodiments, in response to generating the embedded widget, the one or more processors of the embedded services platform may transmit a notification including one or more of an automated email, a text message, or an embedded offer via the embedded widget. The notification may be transmitted to the merchant device 242. The notification may include a link (e.g., uniform recourse locator (URL)) to merchant portal 240. More specifically, the link may be configured to direct merchant device 242 to display the embedded offer widget in merchant portal 240.

The method 700 may include receiving, by the one or more processors of the embedded services platform, a selection of at least one embedded widget of the one or more embed widgets and a merchant access token. For example, merchant device 242 may transmit, through merchant portal 240, a selection of the offer rendered in the embedded offer widget. The selection may trigger workflows 218, as described with reference to FIG. 6. Prior to generating the embedded application widget, embedded services platform 210 may authenticate merchant device 242.

The method 700 may include authenticating, by the one or more processors of the embedded services platform, the merchant device 242 associated with the merchant account. In some embodiments, backend services of the embedded service platform 210 and authentication layer 212 may verify a merchant access token prior to generating the offer application in the embedded shell widget. For example, when merchant device 242 may enter access credentials when accessing merchant portal 240. These access credentials may include a merchant ID and/or an access token. The access credentials may be passed to authentication layer 212 to verify merchant device 242 has access to merchant portal 240 and offers, services, and applications as well as sensitive data presented in merchant portal 240. If the merchant ID and access token are verified, the process may continue.

The method 700 may include generating, by the one or more processors of the embedded services platform, an application widget based on the selection of the at least one widget. As similarly described above, application layer 214 may generate an embedded application widget. Application layer 214 may retrieve configuration data and/or partner styling data from the object registry. In some embodiments, the embedded offer widget and/or offer data used to generate the embedded offer widget may be associated with an offer ID. The offer ID may indicate a partner, provider, and merchant associated with the offer to that object registry is able to retrieve the appropriate configuration data and partner styling data. Object registry may retrieve the configuration data and partner styling data from documents database 222 and/or database 216.

The method 700 may include retrieving, by the one or more processors of the embedded services platform, daily net-sales transaction data of the merchant account. In some embodiments, the daily net-sales transaction data is automatically generated in response to merchant device 242 completing the embedded application widget in merchant portal 240. As described throughout, the offer and application process may be executed through the embedded widgets of embedded services platform 210. The repayment process and terms of the financial capital may have been determined outside of embedded service platform 210. Provider device 252 and/or merchant device 242 may send the contract or governing document to embedded services platform 210, which may execute the repayment process (e.g., through daily net-settled sales). Documents database 222 may store the contract, which may be utilized by other components of embedded services platform 210.

In some embodiments, event-bridge scheduler 330 may schedule and automatically trigger execution of the aggregating and transmitting the daily net-sales transaction data. For example, merchant data, such as merchant transaction data, may be received and updated on a daily basis. The active service may trigger a daily transaction data pipeline 334 of event-bridge scheduler 330. Daily transaction data pipeline 334 may transmit the aggregated daily sales to the provider device 252

The method 700 may include determining, by the one or more processors of the embedded services platform, a selected provider amount and a merchant amount of the net-sales amount based on the daily net-sales transaction data and a service agreement between the selected provider and the merchant. The service agreement may indicate the provider and merchant amount of daily net-sales. A service agreement, contract, and/or similar governing document may be received by data pipeline 220 and stored in documents database 222. Embedded service platform 210 may include a service to parse the document to determine the specific repayment and/or interest data that determines the percentages of daily net-sales for the provider and the merchant. The document may be parsed by extracting the text and converting the extracted text to machine-readable text, for example using optical character recognition (OCR) techniques.

The method 700 may include transmitting, by the one or more processors of the embedded service platform, the selected provider amount to a provider account and the merchant amount to a merchant account. The provider and the merchant may have financial account with the financial institution or entity implementing embedded services platform. Embedded services platform 210 may prompt the response service of the financial institution and/or entity to transmit the provider amount and the merchant amount to the account of provider account and the merchant account, respectively.

In some embodiments, the provider amount and/or the merchant amount may be transmitted to an external financial institution as specified in the agreement between the provider and the merchant. Embedded services platform 210 may prompt the response service of the financial instruction and/or entity to transmit the provider amount and/or merchant amount to the corresponding provider account and/or merchant account identified in the agreement.

Although FIG. 7 shows example flowchart for an exemplary method for embedding partner styling in an application for services and offers from the provider using the embedded services platform 210 of FIG. 2, in some implementations, the exemplary process 600 may include additional blocks, fewer blocks, different blocks, or differently arranged blocks than those depicted in FIG. 6. Additionally, or alternatively, two or more of the layers and/or components of the process 600 may execute functions in parallel.

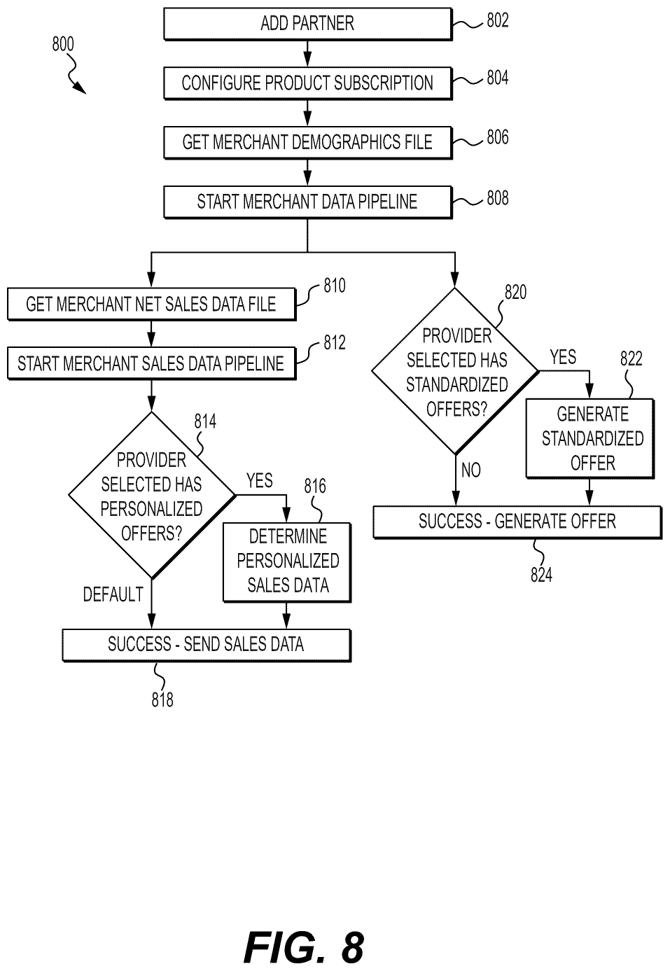

FIG. 8 depicts an example flowchart for an exemplary process 800 for onboarding a partner to the embedded services platform 210 of FIG. 2. Process 800 may be implemented by one or more processors of a server that is in communication with one or more mobile devices and other external system(s) via a network. However, it should be noted that process 800 may be implemented by any one or more of the server, one or more user devices, or other external systems.

The embedded service platform 210 may act as an intermediary among partners, merchants, and providers. In some embodiments, embedded services platform 210 may act as an intermediary for providers of financial services (e.g., financing, payment vehicles, loans, capital, etc.) to work with partners (e.g., integrated software vendors and/or payment facilitators) and merchants. In some embodiments, partners may have existing relationships with a plurality of merchants. Providers may communicate with partners and/or merchants directly to provide financial services. The offers, services, and/or applications from providers and/or partner may be presented in the merchant portal via an embedded widget. Additionally or alternatively, partners and providers may have specific styling and/or theming to present offer, services, and/or applications to the merchants via the embedded widgets of embedded services platform 210. The embedded widget may be rendered to mimic the theming, branding, etc. of the provider and/or partner, without requiring the merchant to leave the merchant portal of the embedded services platform 210.

The process 800 may include a notification to add a partner to the embedded services platform 210 (operation 802). The notification may include a request to add a partner and data associated with the partner. In some embodiments, the request may be received by application layer 214. Application layer 214 may generate an event to add a partner to embedded services platform 210 by an event-triggered workflow 218. The notification may include data associated with the partner such as demographic data, customized theming or styling data, and/or data associating one or more merchants with the partner.

In some embodiments, the notification may be generated and/or transmitted from the administrative portal to application layer 214. The notification received by application layer 214 may include a partner name, a partner type, a partner ID, and partner subscription ID(s). The partner ID may be generated by an internal administrative system to uniquely identify the partner. Similarly, the partner subscription ID(s) may be generated by the internal administrative system to uniquely represent a partner-merchant-provider relationship based on a provider product.

The process 800 may include configuring a partner product subscription (operation 804). In some embodiments, a partner may subscribe to one or more products or services of a provider (e.g., financing, payment vehicles, loans, capital, etc.). Based on the data included in the notification from operation 802, embedded services platform 210 may automatically configure product subscriptions for a partner and one or more providers. The subscription of a partner to a product, may establish a partner product for all of the merchants associated with the partner. For example, by a partner subscribing to a product or service, the provider products may be offered to the merchants associated with the partner through the partner-provider subscription relationship. In some embodiments, embedded services platform 210 may generate a specific subscription ID for each merchant associated with the partner product subscription.

The process 800 may retrieve merchant demographics file (operation 806). In response to configuring the product subscription (operation 804), embedded services platform 210 may retrieve merchant data of the merchant(s) associated with the partner. In some embodiments, the merchant demographic data may be stored in a merchant demographics file or similar data container in database 216 and/or document database 222.

The merchant data may include merchant demographic data that may be relevant to the partner-provider subscription. For example, the data may include identifying information, addresses, contact information, and/or additional data related to the demographics of the merchant. In some embodiments, merchant demographic data may also include industry related categorization or classification of the merchant. For example, the merchant may be a business service, retail service, healthcare service, transportation service, lodging service, and/or a similar organization providing a product or service to consumers. In some embodiments, the merchant demographic data may be anonymized to provide increased security. The merchant, provider, and partner may be identified using a merchant ID, provider ID, and/or partner ID generated by embedded services platform 210.

The process 800 may include initiating a merchant data pipeline (operation 808). The merchant data may be transmitted to one or more providers associated with the partner product subscription via data pipeline 220. In some embodiments, data pipeline 220 may be a secure file transfer service. Additionally or alternatively, data pipeline 220 may be an API that embedded services platform 210 may call. Data pipeline 220 may allow for secure and efficient transfer of data between embedded services platform 210 and one or more providers. There may be an individual data pipeline 220 for each merchant-partner-provider relationship.

The process 800 may include initiating a request to obtain merchant net-sales data (operation 810). Embedded services platform 210 may be implemented by a financial services entity that processes transactions on behalf of the merchant(s), the partner(s), and/or provider(s). The merchant transaction data may be aggregated for specified time intervals. For example, merchant transaction data may be aggregated for a period of days, weeks, months, years, and/or a combination thereof. In some embodiments, data pipeline 220 may be used to periodically send transaction data associated with the merchant based on the partner product subscription.

In some embodiments, the process 800 may include initiating a merchant sales data pipeline (operations 812). Embedded services platform 210 may initiate a second data pipeline, specifically for merchant net-sales data to send the aggregated net-sales data based on the transaction information of the merchant. In some embodiments, the merchant sales data pipeline may utilize the data pipeline initiated during operation 806. Additionally or alternatively, embedded services platform 210 may initiate a data pipeline specifically for transferring aggregated net-sales data.

The process 800 may include determining whether the selected provider has personalized offers (operation 814). The selected provider may be the provider associated with the partner product subscription. In some embodiments, based on whether the selected provider has selected personalized offers, the sales data may be personalized before transmitting to the provider. For example, the provider may request one set of merchant demographic and sales data for loan offers, a second set of merchant demographic and sales data for credit card offers, etc. for each type of product and accompanying offer. The merchant data may only include data pertinent to the personalized offer(s) of the provider and remove arbitrary or unnecessary data from the data set (operation 816).

If the provider has not selected personalized offers, embedded services platform 210 may have standardized categories of data that are aggregated and transmitted to the provider (default operation). In some embodiments, the standardized categories of data may be based on the industry related categorization or classification of the merchant. The merchant sales data and/or merchant demographic data is transmitted to the provider via the net-sales data pipeline and/or data pipeline 220 (operation 818).

The process 800 may include determining whether the selected provider has standardized offers for offer generation (operation 820). In some embodiments operations 820-824 may be performed in parallel to operations 810-818. The selected provider may have selected personalized offers to be generated by the embedded services platform 210, which are generated based on the personalized sales data. In some embodiments, the personalized sales data of operation 816 may be used to generate personalized offers. In some embodiments, the provider may have selected a standardized offer. Embedded services platform 210 may generate a standardized offer based on the industry related categorization or classification of the merchant (operation 822). Embedded services platform 210 may generate standardized or personalized offers based on the selection of the provider (operation 824).

In some embodiments, operations 820-824 may be repeated periodically (e.g., on a daily, weekly, monthly, and/or yearly basis) or after a provider, partner, or merchant trigger. For example, a provider may modify their selection of personalized or standardized offers. An example merchant trigger for repeating operations 820-824 may include updated transaction data and/or a merchant interaction with an existing offer or application widget via merchant portal 240. Additionally or alternatively, operations 820-824 may be automatically repeated based on a modification of the selection.

In some embodiments, at any point through execution of operations 802-824, a processing error may occur. When an error occurs, e.g., failure to retrieve merchant sales data in response to the request due to a network timeout or too many request to retrieve data at once, may be logged. Operations may then be re-executed from the error state, rather than repeating successfully executed operations. Some errors, such as network timeouts and too many requests, may be automatically re-executed in response to the error being logged. In some embodiments, an automatic re-execution may not be able to solve the error. For example, errors may occur in data or the request itself. These errors will be logged, which allows the operations to be restarted at the point of error after troubleshooting.

Although FIG. 8 shows an example flowchart for an exemplary process for onboarding a partner to the embedded services platform 210 of FIG. 2, in some implementations, the exemplary process 800 may include additional blocks, fewer blocks, different blocks, or differently arranged blocks than those depicted in FIG. 8. Additionally, or alternatively, two or more of the layers and/or components of the process 800 may execute functions in parallel.

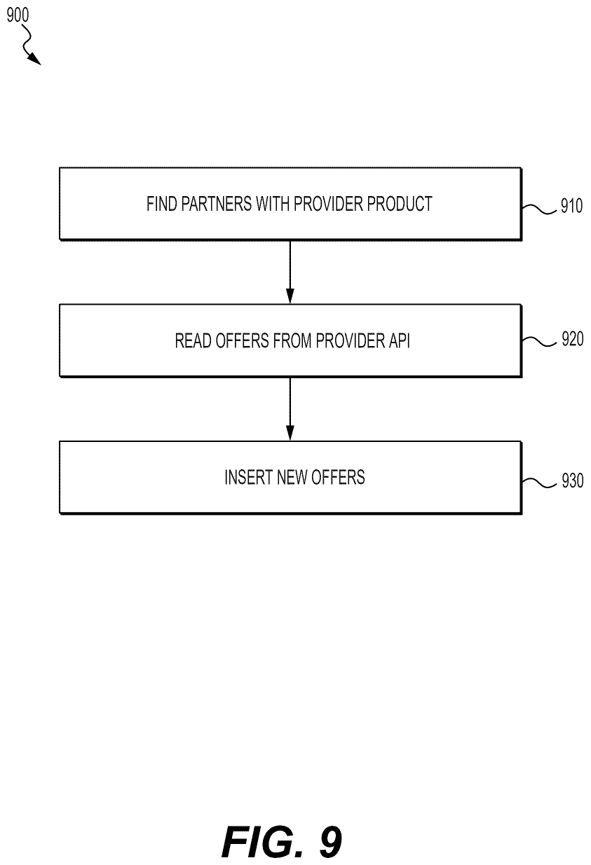

FIG. 9 depicts an example flowchart for an exemplary process 900 for mapping a partner to provider product(s) using the embedded services platform 210 of FIG. 2. Process 900 may be implemented by one or more processors of a server that is in communication with one or more mobile devices and other external system(s) via a network. However, it should be noted that process 900 may be implemented by any one or more of the server, one or more user devices, or other external systems.

The embedded service platform 210 may act as an intermediary among partners, merchants, and providers. In some embodiments, embedded services platform 210 may act as an intermediary for providers of financial services (e.g., financing, payment vehicles, loans, capital, etc.) to work with partners (e.g., integrated software vendors and/or payment facilitators) and merchants.

The process 900 may include finding one or more partners with a provider product (operation 910). In some embodiments, the partners associated with a provider product may be stored in partner subscription table 432 and/or offer table 433 of mapping service 430. Embedded services platform 210 may receive personalized or standardized offers from providers. Application layer 214 may receive provider offer data from provider portal 250. The provider offer data may be received based on sending merchant data, as described with respect to FIG. 8, and/or partner data after onboarding a new partner or updating an existing partner. In some embodiments, application layer 214 may include a provider API. The provider API may receive the provider offer data from provider portal 250. Provider API may trigger a workflow 218 to update or generate new offers.

The process 900 may include reading offers from provider API (operation 920). The provider API may receive provider offer data in the form of a JSON payload. The provider offer data may include offer data specific to a provider product, partner subscription, and/or merchant. Mapping service 430 may determine whether new offers should be generated and/or whether existing offers should be updated. The corresponding workflow 218 may be triggered in response to determining whether new offers should be generated and/or whether existing offers should be updated.

The process 900 may include inserting new offers (operation 930). In some embodiments, provider API of application layer 214 may generate an event to trigger a workflow to update provider offers and/or add new provider offers based on the provider offer data. In some embodiments, provider events handler 322C may receive updated provider offer data, as described with reference to FIG. 4. Provider offers may be updated and stored in offer table 433. In response to an update in offer table 433, offer API of application layer 214 may update or generate an embedded offer widget in merchant portal 240 with the provider offer data.

Although FIG. 9 shows an example flowchart for an exemplary process for onboarding a partner to the embedded services platform 210 of FIG. 2, in some implementations, the exemplary process 900 may include additional blocks, fewer blocks, different blocks, or differently arranged blocks than those depicted in FIG. 9. Additionally, or alternatively, two or more of the layers and/or components of the process 900 may execute functions in parallel.

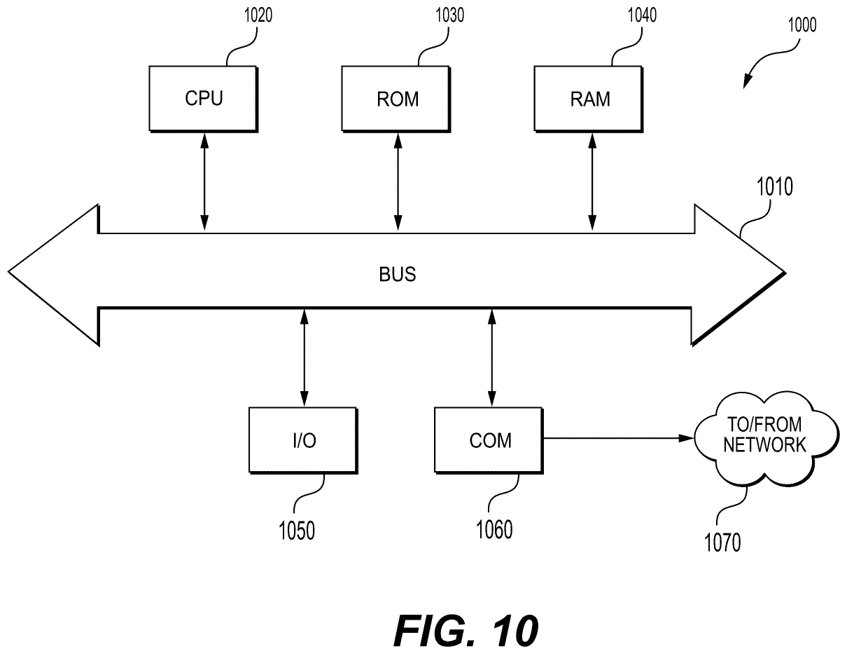

FIG. 10 is a simplified functional block diagram of a device 1000 that may be configured as a device for executing the methods and processes of FIGS. 1-9, according to exemplary embodiments of the present disclosure. For example, device 1000 may include a central processing unit (CPU) 1020. CPU 1020 may be any type of processor device including, for example, any type of special purpose or a general-purpose microprocessor device. As will be appreciated by persons skilled in the relevant art, CPU 1020 also may be a single processor in a multi-core/multiprocessor system, such system operating alone, or in a cluster of computing devices operating in a cluster or server farm. CPU 1020 may be connected to a data communication infrastructure 1010, for example, a bus, message queue, network, or multi-core message-passing scheme.

Device 1000 also may include a main memory 1040, for example, random access memory (RAM), and also may include a secondary memory 1030. Secondary memory 1030, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 1030 may include other similar means for allowing computer programs or other instructions to be loaded into device 1000. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 1000.

Device 1000 also may include a communications interface (“COM”) 1060. Communications interface 1060 allows software and data to be transferred between device 1000 and external devices. Communications interface 1060 may include a modem, a network interface (such as an Ethernet card), a communications port, a PCMCIA slot and card, or the like. Software and data transferred via communications interface 1060 may be in the form of signals, which may be electronic, electromagnetic, optical, or other signals capable of being received by communications interface 1060. These signals may be provided to communications interface 1060 via a communications path 1070 of device 1000, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 1000 also may include input and output ports 1050 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the general description and the detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model/system is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), decision tree, gradient boosting in a decision tree, deep learning, and/or a deep neural network. Supervised and/or unsupervised training may be employed. For example, supervised learning may include providing training data and classifications corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for onboarding a partner in an embedded services platform, the computer-implemented method comprising:
receiving, by one or more processors of the embedded services platform, an event notification associated with onboarding the partner, wherein the event notification includes partner data and subscription data;
determining, by the one or more processors of the embedded services platform, a relevant merchant of the partner based on a mapping table for the partner to one or more products of one or more providers;
aggregating, by the one or more processors of the embedded services platform, one or more merchant datasets corresponding to the relevant merchant;
transmitting, by the one or more processors of the embedded services platform, the one or more merchant datasets to the one or more providers for the relevant merchant; and
generating, by the one or more processors of the embedded services platform, one or more offers associated with the one or more products of the one or more providers based on the one or more merchant datasets and the mapping table.

2. The computer-implemented method of claim 1, wherein the partner data includes one or more of a name of the partner, a type of the partner, or an identifier for the partner.

3. The computer-implemented method of claim 1, further comprising:
storing, by the one or more processors of the embedded services platform, the partner data and the subscription data in a database of the embedded services platform; and
generating, by the one or more processors of the embedded services platform and based on storing the partner data and the subscription data in the database, the mapping table for the partner to the one or more products of the one or more providers.

4. The computer-implemented method of claim 1, wherein the generating the one or more offers further includes:
receiving, by the one or more processors, provider offer data for the one or more providers, wherein the provider offer data indicates a provider selection of a standard offer or a personalized offer.

5. The computer-implemented method of claim 1, wherein the mapping table includes an offer mapping table configured to map the one or more offers with the relevant merchant, the partner, and the one or more providers.

6. The computer-implemented method of claim 1, wherein the one or more merchant datasets include a merchant demographic data set and a net-sales merchant dataset.

7. The computer-implemented method of claim 1, wherein the one or more merchant datasets are personalized based on a set of requested information from the one or more providers.

8. A computer system for onboarding a partner in an embedded services platform, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
receiving, by the one or more processors of the embedded services platform, an event notification associated with onboarding the partner, wherein the event notification includes partner data and subscription data;
determining, by the one or more processors of the embedded services platform, a relevant merchant of the partner based on a mapping table for the partner to one or more products of one or more providers;
aggregating, by the one or more processors of the embedded services platform, one or more merchant datasets corresponding to the relevant merchant;
transmitting, by the one or more processors of the embedded services platform, the one or more merchant datasets to the one or more providers for the relevant merchant; and
generating, by the one or more processors of the embedded services platform, one or more offers associated with the one or more products of the one or more providers based on the one or more merchant datasets and the mapping table.

9. The computer system of claim 8, wherein the partner data includes one or more of a name of the partner, a type of the partner, or an identifier for the partner.

10. The computer system of claim 8, further comprising:
storing, by the one or more processors of the embedded services platform, the partner data and the subscription data in a database of the embedded services platform; and
generating, by the one or more processors of the embedded services platform and based on storing the partner data and the subscription data in the database, the mapping table for the partner to the one or more products of the one or more providers.

11. The computer system of claim 8, wherein the generating the one or more offers further includes:
receiving, by the one or more processors, provider offer data for the one or more providers, wherein the provider offer data indicates a provider selection of a standard offer or a personalized offer.

12. The computer system of claim 8, wherein the mapping table includes an offer mapping table configured to map the one or more offers with the relevant merchant, the partner, and the one or more providers.

13. The computer system of claim 8, wherein the one or more merchant datasets include a merchant demographic data set and a net-sales merchant dataset.

14. The computer system of claim 8, wherein the one or more merchant datasets are personalized based on a set of requested information from the one or more providers.

15. A non-transitory computer-readable medium including instructions for onboarding a partner in an embedded services platform, the instructions comprising:
receiving, by one or more processors of the embedded services platform, an event notification associated with onboarding the partner, wherein the event notification includes partner data and subscription data;
determining, by the one or more processors of the embedded services platform, a relevant merchant of the partner based on a mapping table for the partner to one or more products of one or more providers;
aggregating, by the one or more processors of the embedded services platform, one or more merchant datasets corresponding to the relevant merchant;
transmitting, by the one or more processors of the embedded services platform, the one or more merchant datasets to the one or more providers for the relevant merchant; and
generating, by the one or more processors of the embedded services platform, one or more offers associated with the one or more products of the one or more providers based on the one or more merchant datasets and the mapping table.

16. The non-transitory computer-readable medium of claim 15, wherein the partner data includes one or more of a name of the partner, a type of the partner, or an identifier for the partner.

17. The non-transitory computer-readable medium of claim 15, further comprising:
storing, by the one or more processors of the embedded services platform, the partner data and the subscription data in a database of the embedded services platform; and
generating, by the one or more processors of the embedded services platform and based on storing the partner data and the subscription data in the database, the mapping table for the partner to the one or more products of the one or more providers.

18. The non-transitory computer-readable medium of claim 15, wherein the generating the one or more offers further includes:
receiving, by the one or more processors, provider offer data for the one or more providers, wherein the provider offer data indicates a provider selection of a standard offer or a personalized offer.

19. The non-transitory computer-readable medium of claim 15, wherein the mapping table includes an offer mapping table configured to map the one or more offers with the relevant merchant, the partner, and the one or more providers.

20. The non-transitory computer-readable medium of claim 15, wherein the one or more merchant datasets include a merchant demographic data set and a net-sales merchant dataset.
